(19) United States
(12) Patent Application Publication
(10) Pub. No.: US 2022/0268057 A1
(43) Pub. Date: Aug. 25, 2022

(54) STRAIGHT SHANK ADJUSTABLE COMBINATION LOCK

(71) Applicant: Rogers Joseph Selander, Kingsland, GA (US)

(72) Inventor: Rogers Joseph Selander, Kingsland, GA (US)

(21) Appl. No.: 17/538,079

(22) Filed: Nov. 30, 2021

Related U.S. Application Data
(63) Continuation-in-part of application No. 16/355,945, filed on Apr. 8, 2019, now abandoned.

(51) Int. Cl. E05B 37/02; E05B 67/00

(52) U.S. Cl. CPC E05B 37/02; E05B 67/003

(57) ABSTRACT

The invention is a straight shank combination lock that includes a straight shank and a lock assembly, which, during use, lie between a chain or other device being secured to prevent the shank from being cut.

### BACKGROUND

### Field of the Invention

This invention is related to locks, and more specifically to adjustable combination locks for securing multiple cables, chains, or the like.

### Description of the Related Art

There are existing locks being used by the public to secure items such as chain binders. Conventional U-shaped locks include a shank that is exposed. Exposure of the shank allows criminals and other to compromise the lock by cutting it. There are closed shank locks as well. However, closed shank locks can only secure one or two chains or cables at a time, which limit their use.

What differentiates the present invention is that it is a single shank lock wherein the shank is protected by the object being secured. Since the shank is protected and not exposed it can't be easily cut by those seeking to remove it.

### SUMMARY

The present invention is an adjustable combination lock that includes at least one straight shank and a detachable lock assembly, the straight shank includes a shaft having a first and a second end, at least one lock key disposed between the two ends, and a shank head attached to the first end of the shaft; the detachable lock assembly has a first end cap with an aperture therethrough, a second end cap with an aperture therethrough and an end cap with a diameter that is the same as the first end cap, a plurality of tumblers disposed between the end caps, the tumblers each having a diameter that is less than the diameter of the first end cap and the second end cap, said tumblers having a lock key hole therethrough adapted for communication with said at least one lock key, an incomplete cylindrical casing having a first end permanently attached to more than 50% of a side portion of the first end cap and a second end permanently attached to more than 50% of a side portion of the second end cap, and at least one circular spacer disposed between and in rotational communication with at least one long side of at least one spacer, said at least one spacer having a diameter that is less than the diameter of the first end cap and the second end cap, then at least one spacer comprising an aperture therethrough, whereby the plurality of tumblers and then at least one spacer alternate between said first end cap and said second end cap, and whereby the first end cap and the second end cap are unable to rotate.

### BRIEF DESCRIPTION OF THE DRAWINGS

FIG. 1: is a side, cut-out view of one embodiment of the combination lock of the invention with the casing removed.

FIG. 2: is a side view of a one embodiment of the shank of the invention.

FIG. 3A: is a side view of one embodiment of an end cap of the invention.

FIG. 3B: is a front view of one embodiment of an end cap of the invention.

FIG. 4A: is a front view of one embodiment of a keyed tumbler of the invention.

FIG. 4B: is a side view of one embodiment of a keyed tumbler of the invention.

FIG. 5A; is a front view of one embodiment of a spacer of the invention.

FIG. 5B: is a side view of one embodiment of a spacer of the invention

FIG. 6A is a front view of one embodiment of a casing of the invention.

FIG. 6B is a side view of one embodiment of a casing of the invention.

FIG. 7 is an illustrative perspective view showing use of one embodiment of the adjustable combination lock of the invention to secure a chain.

### DETAILED DESCRIPTION

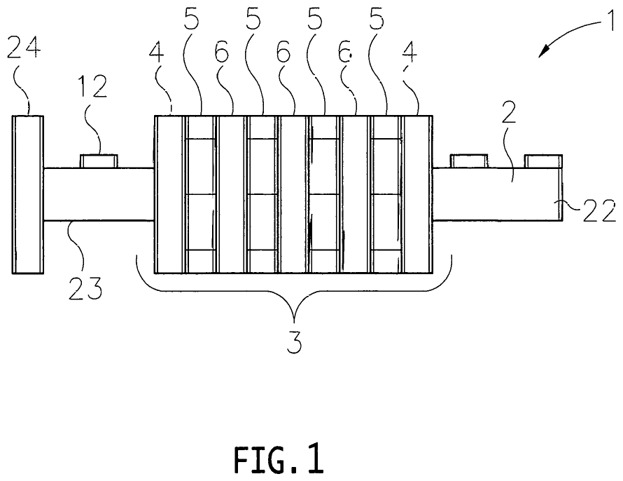

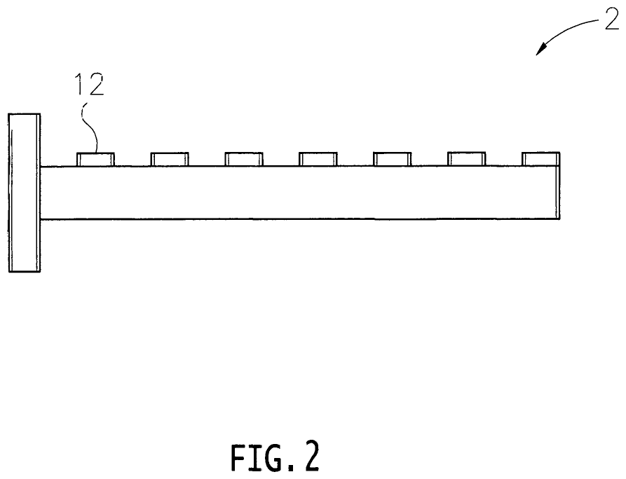

With reference to FIG. 1, and in one embodiment of the invention, an adjustable combination lock 1 is provided that includes a straight shank 2 and detachable combination lock assembly 3. Lock assembly 3 is detachably attached to shank 2 so that assembly 3 may be removed and reattached during use.

Shank 2 has keys 12 that, when tumbler assemble 3 is aligned with the keys it allows tumbler assembly 3 to slide on and off. Once the keyed tumblers are rotated out of alignment with shank 2 the keys it prevents tumble assembly 3 from moving.

Lock assembly 3 comprises first end cap 4 and second end cap 4, each disposed at opposite ends of lock assembly 3 and each comprising aperture 7, adapted to removably accept and attach to shank 2. Lock assembly 3 further comprises at least one spacer 6 and a plurality of keyed tumblers 5, each disposed between first end cap 4 and second end cap 4 in an alternating pattern. Each keyed tumbler 5 (“tumblers”) has a diameter that is less than the diameter of first end cap 4 or second and cap 4. Lock assembly further comprises an incomplete cylindrical casing 8 permanently attached to each end cap 4 such a user only has access to a portion, outside edge 13, of each tumbler 5.

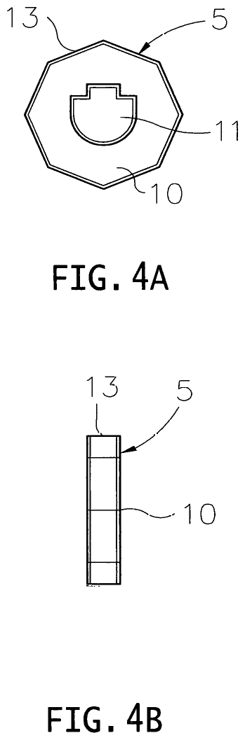

Keyed tumblers 5 are disposed between end caps 4 and are each separated by spacers 6. With reference to FIGS. 1, 4A and 4B, keyed tumblers 5 are generally octagonal in shape. Those of skill in the art will recognize that tumblers 5 may be other shapes, so long as the shapes have at least one flat surface, allowing a user to select an identifier which is written on each side of tumblers 5. Tumblers 5 include an inside edge 10 adapted for rotational contact with at least one spacer 6 and in some instances end cap 4. Tumbler 5 includes an aperture or lock key hole 11 therethrough. Key hold 11 allows shank 2 to fit therewithin and is adapted to fit onto shank keys 12, which are disposed about shank 2. Tumblers 5 also includes an outside edge 13, which is adapted to allow a user to select a unique identifier or symbol, which is about the surface of edge 13. Lock assembly 3 comprises tumblers 5, which may each be different from one another, although duplicate tumblers 5 may also be employed. Each tumbler 50 has a keyhole 11 with a central plane that is different with reference to each side of tumbler 5. Having different tumblers 5 allows the combination locks to have different combination codes.

Any number of tumblers 5 and spacers 6 may be employed within lock assembly 3, so long as there is a plurality of tumblers 5. In one embodiment of the invention, between two and seven tumblers 5 are employed. Accordingly, between one and six spacers 6 are employed.

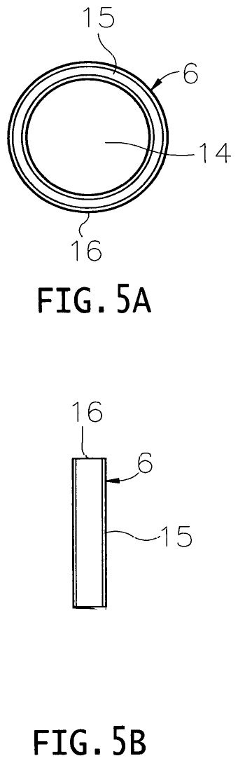

Spacers 6 are in rotational communication with each tumbler 5. With reference to FIGS. 5A and 5B, spacers 6 are generally circular shaped with an aperture 14 centrally located therewithin. Each spacer 6 has two inside edges 15, each in rotational communication with keyed tumblers 5. Spacer 6 also include an outside edge 16, which is adapted to allow a user to rotate spacers 6. Spacer 6 has a diameter that is less than the diameter of end caps 4.

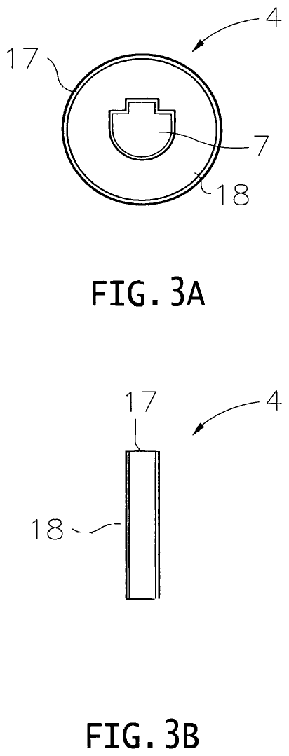

With reference to FIGS. 1, 3A and 3B, end caps 4 comprise an outside edge 17, inside edge 18 and an aperture therethrough 7, which is generally the same shape as aperture 11 of the tumbler. Other shapes may be employed, however. End caps 4 are disposed at opposite ends of lock assembly 3 and have a diameter which is less than the diameter of spacer 6 and tumblers 5. End caps 4 are stationary and can't be moved by a user. Inside edge 18 is in communication with tumblers 5, which do rotate about shank 2.

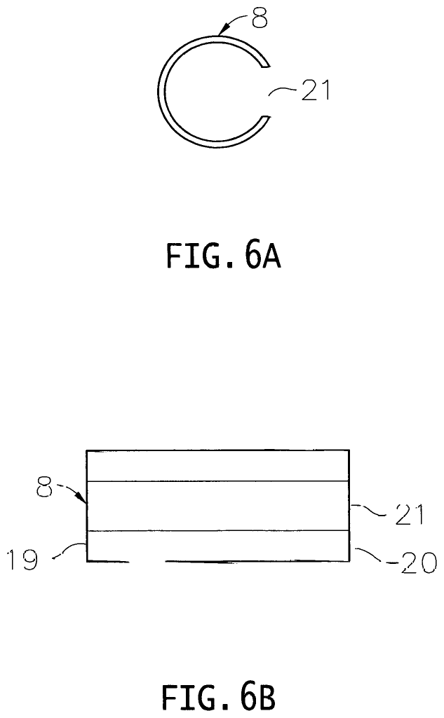

With reference to FIGS. 6A and 6B, lock assembly 3 further comprises casing 8, which has a first end 19 and a second end 20, each disposed about opposite ends of casing 8. Casing 8 is an incomplete cylinder, which is permanently attached to end caps 4 at first end 19 to and the second end 20. Casing 8 is attached to more than 50% of the outside 17 of the end caps 4 Any means for permanently attaching casing 8 to end caps 4 may be used, including welding. An aperture exists with casing 8 to accept the plurality of tumblers 5, spacers 6 and end caps 4. With specific reference to FIG. 6A, casing 8 includes a space to allow access to edge 13 of tumblers 5. Allowing space is integral to the function of lock 1, as it allows a user to select a combination by rotating tumblers 5. The access space must be less than 50% of the body of the cylinder. As is obvious to those of skill in the art, the size of casing 8 is dependent upon the number and size of tumblers 5 and spacers 6 and end cap 4 employed in the lock assembly 3. The size of combination lock assembly 3, and consequently tumblers 5, spacers 6 and end caps 4 is dependent upon the size and shape of the item to be locked or secured.

In a specific embodiment of the invention, the access space is about equal to one side of tumblers 5. In a more specific embodiment of the invention tumblers 5 are octagonal and the access space is equal to about ⅛th of the body of the cylinder. End caps may be of any size, so long as they have a diameter that is larger than the diameter of either spacer 6 or tumblers 5. If end caps 4 have the same diameter as spacer 6 or tumblers 5. casing 8 would prevent rotation of tumblers 5 rendering lock 1 unusable.

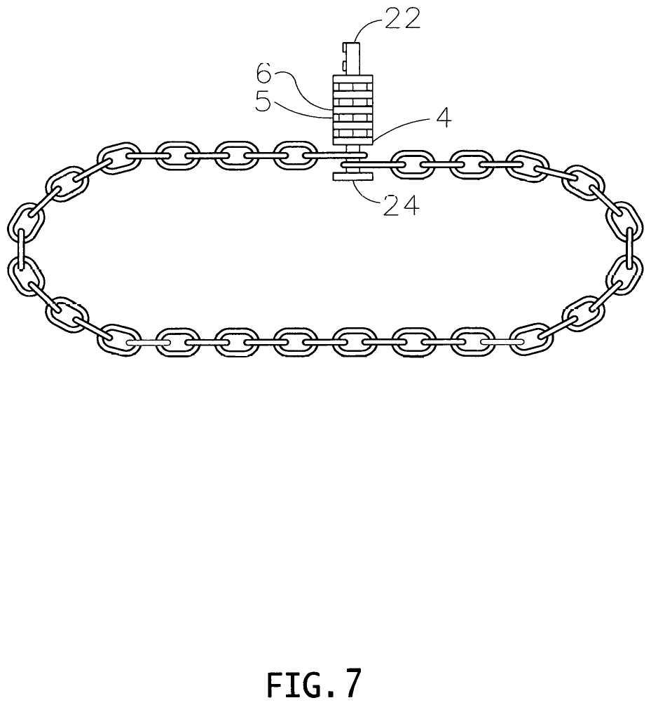

Shank 2 comprises one end 22 and second end 23, each being disposed at opposite ends of shank 2. Shank head 24 is larger than the aperture of the device it is being used to lock. For example, and with reference to FIG. 7, if lock 1 is being used to secure two ends of a chain, shank head 24 must have a diameter that is larger than the chain's aperture. Shank 2 comprises lock keys 12, which are disposed about an outer surface of shank 2 between first end 22 and second end 23. Keys 12 are adapted for flush communication with lock key hole 7 of keyed tumbler 5. The inside diameter of lock key hole 7 is approximately the same shape and size as the outside shape and size of keys 12.

To secure multiple cables or chains, and with reference to FIG. 7, one must insert shank 2 though the spaces between the chain or cable at either end so that shank head 24 abuts the end of the chain, end 23 is within the spaces of the cable or chain, and end 22 is exposed and outside of the chain or cable. Once shank 2 is inserted through the item, lock assembly 3 is then slid over end 22 and shank 2 so end cap is against the chains or cable and a small portion of end 22 is exposed. Tumbler 5 is then turned to secure the lock onto shank 2. Shank head 24 stops the combination lock from sliding through the chain or other device being secured.

To attach lock assembly 3 to shank 2, a user must rotate tumblers 5 and end caps 4 so that lock key holes 7 and apertures 11 are aligned with keys 12 about shank 2. Alignment occurs when a user has positioned the unique identifiers or symbols about tumblers 5 in a manner that corresponds with the combination lock code. Once lock assembly 3 is placed around shank 2, tumblers 5 are rotated to conceal the code. The described lock 1 is unique in that shank 2 is hidden and cannot be compromised. One desiring to cut shank 2 are prevented from doing so due to the presence of lock assembly 3 and the device being locked.

Any heavy-duty metal may be used to make the lock. In a preferred embodiment it is made of steel. Modifications and variations of the lock 1 described are anticipated and within the scope of this invention.

1. An adjustable combination lock comprising:
at least one straight shank comprising
a shaft having a first end and a second end,
at least one lock key disposed about the shaft between the first end and the second end, and
a shank head attached to the first end of the shaft; and
a detachable lock assembly comprising
a first end cap having an aperture therethrough,
a second end cap having an aperture therethrough, said second end cap having a diameter that is the same as the first end cap,
a plurality of tumblers disposed between the first end cap and the second end cap, said tumblers each having a diameter that is less than the diameter of the first end cap and the second end cap, said tumblers having a lock key hole therethrough adapted for communication with said at least one lock key,
an incomplete cylindrical casing having a first end permanently attached to more than 50% of a side portion of the first end cap and a second end permanently attached to more than 50% of a side portion of the second end cap, and
at least one circular spacer disposed between and in rotational communication with at least one long side of at least one spacer, said at least one spacer having a diameter that is less than the diameter that is less than the diameter of the first end cap and the second end cap, the at least one spacer comprising an aperture therethrough,
whereby the plurality of tumblers and the at least one spacer alternate between said first end cap and said second end cap, and
whereby the first end cap and the second end cap are unable to rotate.

2. The adjustable combination lock of claim 1 wherein said tumbler has an outer octagonal shape.

3. The adjustable combination lock of claim 1 comprising between two and seven tumblers.

4. The adjustable combination lock of claim 2 wherein said tumblers each comprise lock key holes that are positioned differently with regard to said outer octagonal shape.

5. The adjustable combination lock of claim 1 wherein the lock is made of metal.

6. The adjustable combination lock of claim 1 wherein the metal is steel.

7. The adjustable combination lock of claim 1 wherein said tumblers are each uniquely marked with at least one symbol.

8. An adjustable combination lock comprising:
at least one straight shank comprising
a shaft having a first end and a second end,
at least one lock key disposed about the shaft between the first end and the second end, and
a shank head attached to the first end of the shaft, wherein the shaft is made of steel; and
a detachable lock assembly comprising
a first end cap having an aperture therethrough,
a second end cap having an aperture therethrough, said second end cap having a diameter that is the same as the first end cap,
between two and seven tumblers disposed between the first end cap and the second end cap, said tumblers each having a diameter that is less than the diameter of the first end cap and the second end cap, said tumblers having a uniquely positioned lock key hole therethrough adapted for communication with said at least one lock key, and said tumblers each being uniquely marked with at least one symbol,
an incomplete cylindrical casing having a first end permanently attached to more than 50% of a side portion of the first end cap and a second end permanently attached to more than 50% of a side portion of the second end cap, and
at least one circular spacer disposed between and in rotational communication with at least one long side of at least one spacer, said at least one spacer having a diameter that is less than the diameter that is less than the diameter of the first end cap and the second end cap, the at least one spacer comprising an aperture therethrough,
whereby the plurality of tumblers and the at least one spacer alternate between said first end cap and said second end cap, and
whereby the first end cap and the second end cap are unable to rotate.
